(19) United States
(12) Patent Application Publication
(10) Pub. No.: US 2009/0091437 A1
(43) Pub. Date: Apr. 9, 2009

(54) Method for monitoring the pressure and assisting in the inflation of a tire of a vehicle wheel

(76) Inventor: Philippe Corniot, Enval (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/919,845

(22) PCT Filed: Apr. 24, 2006
(86) PCT No.: PCT/EP2006/061796

§ 371 Date: Nov. 2, 2007

(30) Foreign Application Priority Data
May 4, 2005 (FR) 0504539

(51) Int. Cl. B60C 23/04

(52) U.S. Cl. 340/442

(57) ABSTRACT

A method for monitoring the inflation pressure and assisting the reinflation of a tire of a wheel of a vehicle equipped with a system specific to the vehicle for monitoring the inflation pressure of the tires. The devices detect the pressure and temperature of the tires of the vehicle, and analyze the pressure and temperature values. The current value of the inflation pressure of the tire is compared with a setpoint pressure that is corrected as a function of the tire temperature provided by the device for detecting the temperature of the tire concerned and corresponding to a reference temperature dependent on the temperatures measured during the most recent starts of said vehicle.

The present invention relates to a method for monitoring the pressure and assisting the inflation of a tire of a wheel of a vehicle as well as to a device for implementing the method.

To obtain the best performance, which customarily results from a compromise between wear, grip and comfort, and which conditions good road holding, good braking, good suspension, low level of rolling noise, good damping of vibrations, etc., the vehicle/wheel/tire assembly must work at pressures having values very close to the pressure setpoint values advocated for the inflation of the tires. These pressure setpoint values are generally fixed by agreement between the motor vehicle constructors and the tire manufacturers to correspond to a given vehicle/wheel/tire assembly for given conditions of mass, speed and stability, and for cold tires, that is to say without heating due to rolling. Continuous rolling with under-inflated tires can lead to a decrease in the performance of the tires, such as rolling resistance, endurance, comfort, etc. Conversely, over-inflated tires can lead to a degradation in the grip of the tires and in the comfort of the vehicle and to accelerated tire wear. As bad inflation of the tires can lead to not inconsiderable consequences, automobile constructors and tire manufacturers generally recommend that the pressure of the tires be maintained in a narrow pressure span, generally less than 10 percent of the advocated setpoint value, or, for an advocated setpoint value of 2 bars, a maximum pressure difference of the order of 200 millibars with respect to said setpoint value.

During an inflation operation with the aid of a self-service inflation machine installed in a petrol filling station or a supermarket, drivers do not generally take account of the state of the tires of their vehicle or, when they want to take account thereof, they encounter difficulties. Specifically, surveys have shown that:
drivers rarely adjust the pressure of the tires of their vehicle cold; generally, they travel several kilometers before stopping at an inflation station and they do not know whether it is necessary to take account of a heating of the tires and, if appropriate, to what extent it should be taken into account;
drivers may monitor the pressures after or during a long journey;
drivers cannot take account of the temperature differences between tires that have been exposed to the sun and tires that have remained in the shade, and/or take account of the heating differences between the tires belonging to the front and rear axles;
during cold periods (fall, winter and spring), drivers adjust the pressure of the tires of their vehicle rathermore in the middle or at the end of the day, therefore at a time when the ambient temperature is usually higher than at the beginning of the day;
often drivers adjust the pressure of the tires of their vehicle only once a year, when departing on long vacations, generally in the summer, therefore at a period when the ambient temperature is relatively high.

Hence in numerous cases, the inflation of the tires is performed at a time when the tires are in a hot state. In this case, if the pressure of the tires is adjusted to the setpoint value advocated by the constructor of the motor vehicle, the tires might be under-inflated. It can even happen that, if the tires have been heated a great deal, the driver notes that the pressure is higher than the setpoint value advocated by the constructor and that, seeing this, the driver deflates the tires while they were at a correct pressure or that they ought to have been reinflated if the pressure had been measured when cold. In the latter case, it may turn out that the tires are or become noticeably under-inflated without the driver knowing it, and this may have multiple consequences, such as those indicated above.

When drivers call upon a professional in a service station to inflate the tires of their vehicle, usually the professional applies a radical solution consisting in systematically inflating the tires by adding 0.3 to 0.4 bar, or more, to the setpoint value advocated by the constructor. Such a solution is not satisfactory either, since it can lead to exaggerated inflation of the tires and to degraded performance, in particular from the viewpoint of the wear of the tires and the comfort of the vehicle.

Motor vehicles are known whose wheels are furnished with a pressure monitoring system, commonly called a TPMS system (abbreviation of the English expression Tire Pressure Monitoring System). TPMS systems generally comprise a pressure sensor and/or a pressure variation detector, as well as a management module capable of receiving and processing information provided by the pressure sensor and/or the pressure variation detector and an emitter module for transmitting to a receiver independent of the wheel the information analyzed and processed by the management module (see in particular the international patent applications published under the Nos. WO 02/34551, WO 02/34552 and WO 02/34553). As appropriate, the information transmitted to the receiver is used to warn the driver of an automobile of an anomaly, such as for example insufficient pressure inside the cavity of the tire, a puncture, a rapid loss of pressure, a burst, etc.

Even with vehicles equipped with a TPMS system, the monitoring of correct inflation of the tires and inflation itself are not easy. Specifically, the alarm triggering threshold of TPMS systems is customarily not very far from the setpoint value advocated by the constructor for the inflation pressure, for example −300 to −400 millibars. It follows from this that if a driver resets the pressure of the tires of his vehicle in the afternoon, for example after his work, while the ambient temperature is about 20° C., and after having driven a little, thus giving rise to heating of the tires of at least 10° C. plus the ambient temperature, i.e. in total a temperature of the tires of at least 30° C., the next morning, when cold, if the ambient temperature is for example 0° C., the pressure of the tires will have easily dipped by at least 300 millibars below the pressure set by the driver during the inflation performed the previous afternoon, that is to say the tires may be at a pressure very close to the alarm triggering threshold. The alarm may therefore be triggered and, if this occurs, the driver will reset the pressure of the tires according to his experience, usually in the afternoon after his work, so that the same phenomenon might possibly recur the next morning and on subsequent days without the driver understanding the phenomenon. This causes the driver a certain amount of confusion and/or weariness. On the other hand, if the driver has had the pressure of the tires reset by a professional who has excessively overinflated the tires, the TPMS system does not necessarily emit an alarm, but this situation is not satisfactory either, since it may make the tires operate outside the conditions for which they were envisaged.

The present invention is therefore aimed at solving the problems indicated above by providing a method making it possible to inflate and to monitor as correctly as possible a tire of a vehicle wheel even if the tire is hot or has been driven on a long journey before its pressure is readjusted, doing so at whatever time of the day the readjustment of the pressure is performed.

For this purpose, the present invention is aimed at a method for monitoring the pressure and assisting the inflation to a correct pressure of a tire of a wheel of a vehicle equipped with a device specific to the vehicle for monitoring the inflation pressure of the tires comprising devices for detecting the pressure and temperature associated with the various tires of the vehicle and means for analyzing said pressure and temperature values. This method is characterized in that the analysis means compare the current value of the inflation pressure of the tire with a setpoint pressure that is corrected as a function of the tire temperature provided by the device for detecting the temperature of the tire concerned and corresponding to a reference temperature dependent on the temperatures measured during the most recent starts of the vehicle.

Preferably the corrected setpoint pressure is given by the formula:

$${P}_{cc} = {P}_{c} \cdot \frac{{T}_{p}}{{T}_{ref}}$$

in which P_{c} is the nominal setpoint value of the inflation pressure of the tire concerned, P_{cc} is said corrected setpoint value for the inflation pressure, Tₚ is the tire temperature provided by the temperature sensor, and T_{ref} is the variable reference temperature which is chosen as being a temperature dependent on the temperatures measured during the most recent starts of said vehicle; the pressures P_{c} and P_{cc} being absolute values and the temperatures Tₚ and T_{ref} being degrees K.

The setpoint pressure P_{c} is the nominal setpoint pressure when cold provided by the constructor of the vehicle considered. The corrected setpoint pressure has the advantage of taking into account the real temperature of the tire, that is to say the temperature of the internal cavity defined by the tire and the rim of the wheel. This method is therefore applicable whether the tire is in a hot state or a cold state. The correction also uses a reference temperature T_{ref}. This temperature is dependent on the temperatures previously measured and recorded by the monitoring system during the most recent starts of the vehicle. This makes it possible to take into account the climatic variations related to recent days and therefore to avoid the drawbacks previously cited.

According to a particular embodiment, the temperature dependent on the temperatures measured during the most recent starts of said vehicle corresponds to the minimum temperature out of the n most recent stored temperatures: The value of n advantageously lies between three and ten and is preferably of the order of five.

Each stored temperature can be the average of the temperatures measured by the devices for detecting the temperature of the tires of the vehicle, each considered start of the vehicle then is a so-called “cold” start, that is to say the vehicle stoppage time has been greater than two hours in the case of passenger vehicles.

When the vehicle is equipped with an ambient temperature sensor, each stored temperature can be provided by this ambient temperature sensor.

When the device for monitoring the inflation pressure of the tires comprises a device for measuring the atmospheric pressure, the corrected setpoint value P′_{cc}, as a relative value, can be calculated via the formula:

P′_{cc}=(P′_{c}+Pₐₜₘ)[(tₚ+273)/(t_{ref}+273)]−Pₐₜₘ

in which P′_{c} is the setpoint value, as a relative value, for the inflation pressure, Pₐₜₘ is the value of the measured atmospheric pressure, tₚ and t_{ref} are the temperature of the tire and the variable reference temperature in degrees C.

When the system for monitoring the pressure comprises means for dialoguing with the driver of the vehicle, the method according to the invention can furthermore comprise a complementary step in which complementary information is provided by the operator to the analysis means indicating the load state of the vehicle. This complementary information is then taken into account to define the setpoint pressure (P_{c}) for the inflation pressure to be used in calculating the corrected setpoint value (P_{cc}, P′_{cc}).

Another useful item of complementary information for choosing the setpoint pressure to be used and given by the driver of the vehicle can be the range of speeds of projected use of the vehicle.

In an advantageous manner, the system for monitoring the pressure of the tires of the vehicle comprises a normal operating mode intended to warn the driver of the vehicle during an abnormal state of one at least of the tires of the vehicle and a reinflation assistance operating mode and the switchover from the normal operating mode to the reinflation assistance operating mode occurs when the system receives an operator instruction.

When the system is in monitoring and inflation assistance mode, the system analysis means advantageously transmit, to the means for dialoguing with the driver, information indicating, as appropriate, too high an inflation pressure, too low an inflation pressure or a correct inflation pressure.

The correct inflation pressure information is advantageously transmitted when the inflation pressure lies between the corrected setpoint pressure and this corrected setpoint pressure increased by 200 mbar.

The method according to the invention thus makes it possible, instead of transmitting an alarm when there are large temperature variations in one and the same day for example, to recommend reinflation or deflation of the tire as soon as the pressure deviates slightly from the corrected setpoint pressure.

According to a simple mode of implementation, the vehicle being equipped with four tires, after switchover to monitoring and reinflation assistance mode, the monitoring device transmits information to the operator about the inflation state of the four tires of the vehicle by means of the direction indicator lamps of the vehicle:
lamp off: inflation pressure correct;
lamp on continuously: inflation pressure insufficient:
lamp on flashing: inflation pressure too high.

This indication transmitted by the direction indicator lamps of the vehicle is particularly practical when the driver is currently performing a deflation/inflation operation on the tires thereof.

The monitoring device can switch over to normal mode when:
it receives an end-of-reinflation instruction from the operator; or
the operator switches off; or
when the speed of the vehicle becomes greater than a given threshold; or
after a given time without modification of inflation pressure of one of the tires; or
after a given maximum time.

Other characteristics and advantages of the invention will appear in the course of the following description of an embodiment of the invention given by way of example with reference to the drawings appended in which:

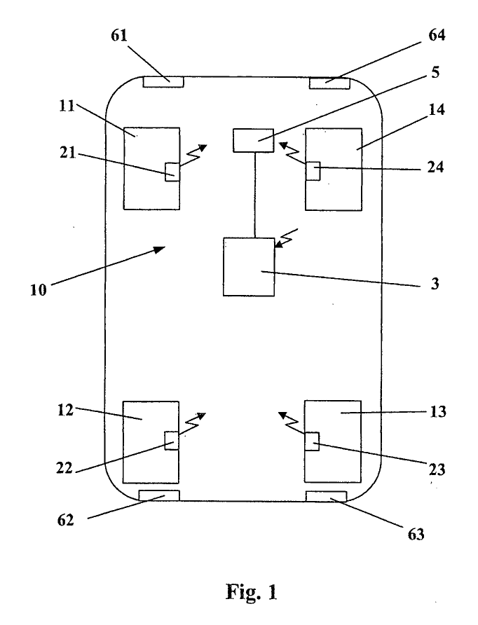

FIG. 1 schematically presents a device for implementing the method according to the invention; and

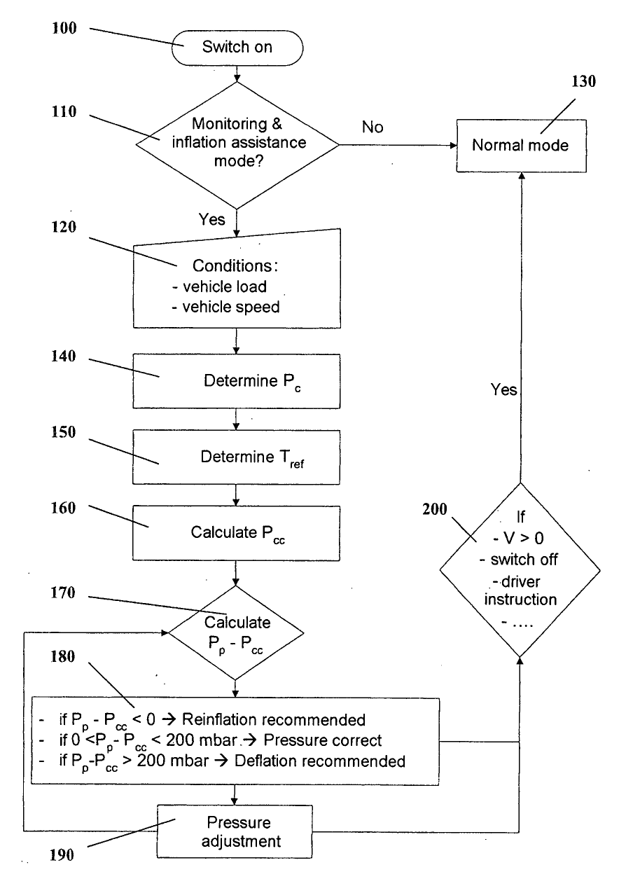

FIG. 2 is a flowchart of an exemplary implementation of the method according to the invention.

Seen schematically in FIG. 1 is a vehicle 1 equipped with a system 10 for monitoring the pressure of the tires. This vehicle comprises four tires 11, 12, 13 and 14. The system 10 comprises for each tire 11, 12, 13 and 14 a wheel module 21, 22, 23, 24. Each wheel module comprises at least one device for measuring the inflation pressure of the tire and a device for measuring the internal temperature of the fluid for inflating the tire as well as a radio emitter. The wheel modules are disposed in the internal cavities defined by the tires and the wheels. The system 10 also comprises a central unit 3 placed in the vehicle. This central unit 3 comprises at least one radio receiver and means for analyzing the pressure and temperature measurements. The system also comprises a display 5 intended to transmit to the driver of the vehicle the information formulated by the system analysis means. This display also comprises means for dialoguing with the driver, for example pushbuttons or a tactile screen making it possible to receive information from the driver. Each wheel module 21, 22, 23 and 24 regularly dispatches pressure and temperature measurements to the central unit. These measurements are processed by the central unit analysis means and the system transmits information or alarms to the driver as appropriate by means of the display 5. The vehicle also comprises four direction indicators 61, 62, 63 and 64.

FIG. 2 presents a flowchart of an exemplary implementation of the method according to the invention.

In step 100, the driver switches on. The system 10 is initialized and the display 5 gives the choice between the monitoring and inflation assistance mode or the normal mode (step 110).

If the driver transmits the “monitoring and inflation assistance mode” command to the system by means of the display 5, the system asks for a choice between two or three values as appropriate the load of the vehicle (average load, full load) and the speed of use conditions (town, highway)—step 120.

The system determines the nominal pressure PC appropriate to the load and speed conditions indicated on the basis of data registered in a memory of the central unit analysis means—step 140.

In step 150, the system determines the reference temperature T_{ref} on the basis of the temperatures measured successively during the five most recent cold starts of the vehicle. Each recorded temperature can be the average of the temperatures given by the four devices for measuring the temperature of the wheel modules or the temperature measured by the device for measuring the exterior temperature of the vehicle, if it is equipped with one. The reference temperature is preferably the minimum value of the five most recent temperatures recorded during cold starts. This implies that account is taken of the evolution of the ambient temperature in recent days preceding the monitoring. Account is taken of the minimum value because it is preferable for the tires to have an inflation pressure that is slightly higher than the recommended pressure rather than slightly lower.

In step 160, the corrected setpoint pressure is calculated by taking into account the reference temperature T_{ref} and the temperature measured at the time of monitoring by the device for measuring the temperature of the wheel module of the tire concerned. This makes it possible to take account of the hot or cold state of the tire.

The corrected setpoint pressure P_{cc} is given by the formula:

$${P}_{cc} = {P}_{c} \cdot \frac{{T}_{p}}{{T}_{ref}}$$

in which P_{c} is the nominal setpoint value of the inflation pressure of the tire concerned, Tₚ is the tire temperature provided by the temperature sensor, and T_{ref} is the variable reference temperature; the pressures P_{c} and P_{cc} being absolute values and the temperatures Tₚ and T_{ref} being degrees K.

In step 170, the analysis means of the central unit 3 calculate:

Pₚ−P_{cc}

where Pₚ is the pressure measured at the time of monitoring by the device for measuring the pressure of the tire concerned and P_{cc} the corrected setpoint pressure.

The system then transmits the following information to the driver via the display 5 (step 180):

if Pₚ−P_{cc}<0, reinflation recommended;

if 0<Pₚ−P_{cc}<200 mbar, pressure correct;

if Pₚ−P_{cc}>200 mbar, deflation recommended.

It should be noted that the system 10 does not transmit an alarm to the driver but simply a recommendation intended to optimize the inflation pressure of the tires and to limit the number of inopportune alarms.

If the driver performs this monitoring with a view to an adjustment of the pressure of his tires, it is advantageous that at the same time the system transmits an indication that can be understood by a person placed outside the vehicle. Such an indication can be transmitted by the direction indicators 61, 62, 63, 64 of the vehicle. Each direction indicator is then actuated according to the following indicative diagram:

lamp off: inflation pressure correct;

lamp on continuously: inflation pressure insufficient;

lamp on flashing: inflation pressure too high.

These indications are complementary to those transmitted to the driver via the display 5 and are very useful for facilitating inflation of the tires to a correct pressure.

Finally, in step 200, the system switches over to normal mode when the driver moves the vehicle forward, or when he switches off, or when an instruction to leave the monitoring and inflation assistance mode is transmitted via the display 5, or when a given time has elapsed without any modification of inflation pressure of one of the tires, or after a given maximum time.

The method according to the invention can be implemented at the request of the driver when he is ready to adjust the pressure of the tires of the vehicle but also at each start, or indeed at any time, when the vehicle is stopped, to obtain a quality recommendation regarding the current inflation pressure of his tires.

The above embodiment has been presented merely by way of example and numerous modifications can be made by the person skilled in the art without however departing from the scope of the invention, as defined by the following claims.

1. A method for monitoring the inflation pressure and assisting the reinflation of a tire of a wheel of a vehicle equipped with a system specific to the vehicle for monitoring the inflation pressure of the tires comprising devices for detecting the pressure and temperature of the tires and means for analyzing said pressure and temperature values, wherein the analysis means compare the current value of the inflation pressure of the tire with a setpoint pressure that is corrected as a function of the tire temperature provided by the device for detecting the temperature of the tire and corresponding to a reference temperature dependent on the temperatures measured during the most recent starts of said vehicle.

2. The method as claimed in claim 1, in which the corrected setpoint pressure is given by the formula:
$${P}_{cc} = {P}_{c} \cdot \frac{{T}_{p}}{{T}_{ref}}$$
in which P_{c} is the nominal setpoint value of the inflation pressure of the tire concerned, P_{cc} is said corrected setpoint value for the inflation pressure, Tₚ is the tire temperature provided by the temperature sensor, and T_{ref} is the variable reference temperature which is chosen as being a temperature dependent on the temperatures measured during the most recent starts of said vehicle; the pressures P_{c} and P_{cc} being absolute values and the temperatures Tₚ and T_{ref} being degrees K.

3. The method as claimed in claim 1, in which the temperature dependent on the temperatures measured during the most recent starts of said vehicle corresponds to the minimum temperature out of the n most recent stored temperatures.

4. The method as claimed in claim 3, in which n lies between 3 and 10.

5. The method as claimed in claim 1, in which each stored temperature is the average of the temperatures measured by the devices for detecting the temperature of the tires of the vehicle and in which each start considered is a so-called “cold” start.

6. The method as claimed in claim 1, in which, said vehicle being equipped with an ambient temperature sensor, each stored temperature is provided by said ambient temperature sensor.

7. The method as claimed in claim 1 in which, the device for monitoring the inflation pressure of the tires comprising a device for measuring the atmospheric pressure, the corrected setpoint value P′_{cc}, as a relative value, is calculated via the formula:
P′_{cc}=(P′_{c}+Pₐₜₘ)[(tₚ+273)/(t_{ref}+273)]−Pₐₜₘ
in which P′_{c} is said setpoint value, as a relative value, for the inflation pressure, Pₐₜₘ is the value of the measured atmospheric pressure, tₚ and t_{ref} are said temperature of the tire and said variable reference temperature in degrees C.

8. The method as claimed in claim 1, in which, the system for monitoring the pressure comprising means for dialoguing with the driver of the vehicle, complementary information is provided by the driver to the analysis means indicating the load state of the vehicle and in which said complementary information is taken into account to define the setpoint pressure (P_{c}) for the inflation pressure to be used in calculating the corrected setpoint value (P′_{cc}).

9. The method as claimed in claim 1, in which, the system for monitoring the pressure comprising means for dialoguing with the driver of the vehicle, complementary information is provided by the driver to the analysis means indicating the range of speeds of use of the vehicle and in which said complementary information is taken into account to define the setpoint pressure (P_{c}) for the inflation pressure to be used in calculating the corrected setpoint value (P_{cc}, P′_{cc}).

10. The method as claimed in claim 1, in which, the system for monitoring the pressure of the tires of the vehicle comprising a normal operating mode intended to warn the driver of the vehicle during an abnormal state of one at least of the tires of the vehicle and a monitoring and reinflation assistance operating mode and means for dialoguing with the driver, the switchover from the normal operating mode to the reinflation assistance operating mode occurs when the system receives a driver instruction.

11. The method as claimed in claim 8, in which the analysis means transmit, to the means for dialoguing with the driver, information indicating respectively too high an inflation pressure, too low an inflation pressure or else a correct inflation pressure.

12. The method as claimed in claim 11, in which, the vehicle being equipped with four tires, after switchover to monitoring and reinflation assistance mode, the monitoring device furthermore transmits information about the inflation state of the four tires of the vehicle by means of the direction indicator lamps of the vehicle:
lamp off: inflation pressure correct;
lamp on continuously: inflation pressure insufficient;
lamp on flashing: inflation pressure too high.

13. The method as claimed in claim 10, in which the monitoring device switches over to normal mode when:
it receives an end-of-reinflation instruction from the operator; or
the driver switches off; or
when the speed of the vehicle becomes greater than a given threshold; or
after a given time without modification of inflation pressure of one of the tires; or
after a given maximum time.
